(19) United States
(12) Patent Application Publication
(10) Pub. No.: US 2017/0371850 A1
(43) Pub. Date: Dec. 28, 2017

(54) PHONETICS-BASED COMPUTER TRANSLITERATION TECHNIQUES

(71) Applicant: Google Inc., Mountain View, CA (US)

(72) Inventor: Padmaksha Mukhopadhyay, Bangalore (IN)

(73) Assignee: Google Inc., Mountain View, CA (US)

(21) Appl. No.: 15/189,241

(22) Filed: Jun. 22, 2016

(51) Int. Cl. G06F 17/22; G06F 17/27

(52) U.S. Cl. CPC G06F 17/2223; G06F 17/2735; G06F 17/2211; G06F 17/2288

(57) ABSTRACT

Computer-implemented techniques can include obtaining, by a computer server having one or more processors, a phonetics-based character mapping between a source script and a different target script, the phonetics-based character mapping relating characters in the source and target scripts that have similar sounds or pronunciations. The techniques can include encoding, by the computer server, each character of the phonetics-based character mapping using an encoding scheme to obtain an encoded character mapping, wherein the encoding scheme is common to both the source and target scripts. The techniques can include generating, by the computer server, a mapping function that directly maps encoded source script characters to encoded target script characters in the encoded character mapping. The techniques can also include in response to a transliteration request, utilizing, by the computer server, the mapping function to transliterate a text from the source script to the target script.

### FIELD

The present disclosure generally relates to language transliteration and, more particularly, to phonetics-based computer transliteration techniques.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Given the worldwide reach of the Internet, there is a need for all possible users to be able to input text to a computer in their respective languages. Some languages (e.g., Chinese) can include thousands or tens of thousands of distinct characters. Due to size constraints for computer input devices (physical keyboards, touchscreen virtual keyboards, etc.), however, there is a need for more efficient input of characters in such languages. Transliteration refers to the process of converting a text from a first writing system (a first “script”) to a different second script. Examples of common transliterations include, but are not limited to, transliteration from English (e.g., Roman characters) to Hindi (e.g., Devanagari characters) or from English to Chinese (e.g., Hanzi characters).

### SUMMARY

A computer-implemented technique and a computer server configured to implement the technique are presented. The technique can include obtaining, by a computer server having one or more processors, a phonetics-based character mapping between a source script and a different target script, the phonetics-based character mapping relating characters in the source and target scripts that have similar sounds or pronunciations. The technique can include encoding, by the computer server, each character of the phonetics-based character mapping using an encoding scheme to obtain an encoded character mapping, wherein the encoding scheme is common to both the source and target scripts. The technique can include generating, by the computer server, a mapping function that directly maps encoded source script characters to encoded target script characters in the encoded character mapping. The technique can also include in response to a transliteration request, utilizing, by the computer server, the mapping function to transliterate a text from the source script to the target script.

In some implementations, utilizing the mapping function to transliterate the text includes: encoding, by the computer server, source characters of the text using the encoding scheme to obtain encoded source characters, utilizing the mapping function, replacing, by the computer server, the encoded source characters with corresponding encoded target characters, and decoding, by the computer system, the encoded target characters using the encoding scheme to obtain target characters of the transliterated text.

In some implementations, the technique further includes receiving, at the computer server and from a computing device, an upload comprising (i) a document file including the text and (ii) the transliteration request, converting, by the computer server, the document file to a plain text tabular data structure to obtain a converted document file, utilizing, by the computer server, the mapping function to convert the text in the converted document file from the source script to the target script to obtain a transliterated document file including the transliterated text, and transmitting, from the computer server and to the computing device, the transliterated document file. In some implementations, the plain text tabular data structure is comma-separated values (CSV).

In some implementations, the technique further includes: obtaining, by the computer server, encoded target words from the transliterated document file by using a space character as a delimiter, utilizing the mapping function, replacing, by the computer server, the target encoded words with encoded source words, decoding, by the computer server, the encoded source words using the encoding scheme to obtain source words in the source script, and utilizing, by the computer server, the source words to create a dictionary for a target language associated with the target script.

In some implementations, utilizing the source words to create the target language dictionary includes: comparing, by the computer server, the source words to known source words in a database associated with the target language dictionary, and when the source words to not match any known source words, adding, by the computer server, the source words to the target language dictionary.

In some implementations, the technique further includes: receiving, at the computer server and from a computing device, an input comprising (i) the text (ii) the transliteration request, utilizing, by the computer server, the mapping function to convert the text from the source script to the target script to obtain a transliterated text, and outputting, from the computer server and to the computing device, the transliterated text.

In some implementations, the phonetics-based character mapping is a data structure that includes (i) source sets of characters in the source script having similar sounds or pronunciations as and separated by a colon from (ii) respective target sets of characters in the target script. In some implementations, the mapping function is the HashMap function. In some implementations, the encoding scheme is Unicode.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a diagram of an example computing system according to some implementations of the present disclosure;

FIG. 2 is a functional block diagram of an example computing device of the example computing system of FIG. 1; and

FIG. 3 is a flow diagram of an example phonetics-based computer transliteration technique according to some implementations of the present disclosure.

### DETAILED DESCRIPTION

Computer transliteration can be a difficult task, particularly when a user wishes to transliterate an entire document file. Accordingly, improved phonetics-based computer transliteration techniques are presented. The techniques involve creating a phonetics-based mapping between a source language (e.g., Hindi) and a target language (e.g., English). This mapping can then be encoded (e.g., Unicode) and encoded source characters can be mapped to encoded target characters using a mapping function (e.g., HashMap). This mapping function can be generated or learned by determining the direct mappings between corresponding encoded source and target characters. The mapping function can then be utilized to convert encoded source characters (a string, an entire document, etc.) to encoded target characters, or vice-versa, which can subsequently be decoded and output. For an entire document, the document may first be converted to a more appropriate format for processing, such as a plain text tabular data structure.

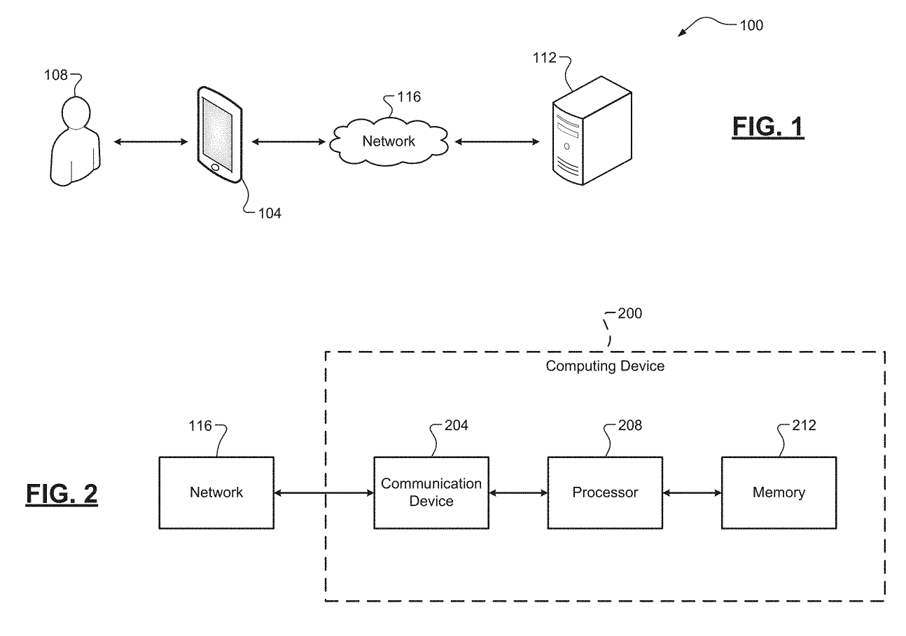

Referring now to FIG. 1, a diagram of an example computing system 100 is illustrated. A computing device 104 operated by a user 108 can communicate with a computer server 112 via a network 116. The computing device 104 can be any suitable computing device (a desktop computer, a laptop computer, a tablet computer, a mobile phone, etc.) configured to perform at least a portion of the techniques of the present disclosure (e.g., upload a file to and download a transliterated file from the computer server 112 via the network 116). The computer server 112 can be any suitable computing device configured to perform at least a portion of the techniques of the present disclosure (e.g., receive the file, store and apply a mapping/mapping function, and output the transliterated file). The phrase “computer server” as used herein can refer to both a single computer server and two or more computer servers operating in a parallel or distributed architecture. The network 116 can be a local area network (LAN), a wide area network (WAN), e.g., the Internet, or a combination thereof.

The computer server 112 can initially create a phonetics-based character mapping between characters of the source script (e.g., Devanagari, for Hindi) and characters of the target script (e.g., Roman, for English). This character mapping is phonetics-based because it is representative of how source script characters will be pronounced through target script words. Examples of phonetic descriptions of particular characters include short forms, long forms, vocalic forms, candra forms, and the like. This phonetics-based mapping can also take into account special features of the scripts, such as accents or diacritics (e.g., matras and special characters for Hindi). For illustrative purposes, a small portion of an example Hindi-to-English phonetics-based character mapping is shown below in Table 1:

TABLE 1

| Devanagari | Phonetic-Based Roman |
|---|---|
| [symbol] | DEVANAGARI LETTER A |
| [symbol] | DEVANAGARI LETTER AA |
| [symbol] | DEVANAGARI LETTER I |
| [symbol] | DEVANAGARI LETTER II |
| [symbol] | DEVANAGARI LETTER U |
| [symbol] | DEVANAGARI LETTER UU |
| [symbol] | DEVANAGARI LETTER VOCALIC R |
| [symbol] | DEVANAGARI LETTER VOCALIC L |
| [symbol] | DEVANAGARI LETTER CANDRA E |
| [symbol] | DEVANAGARI LETTER SHORT E |

The computer system 112 can encode the phonetic-based mapping to obtain an encoded mapping between the source script and the target script. This encoding, for example, can be any suitable encoding that can be used for all scripts/languages. One primary example is Unicode. Unicode is a standard for encoding of text expressed in most of the world's writing systems, and includes unique codes for more than 100,000 different characters across more than 100 different scripts. Once the encoded mapping is obtained, a mapping function can then be generated by the computer system 112. This mapping function can represent a direct mapping between different encoded characters that already have been mapped phonetically (e.g., as having the same sound). In one implementation, the techniques of the present disclosure are Java-based and the mapping function can be the HashMap function. HashMap represents a specific table-based implementation of the more basic Map function.

For illustrative purposes, a small portion of an example Hindi-to-English encoded mapping is shown below in Table 2:

TABLE 2

| Devanagari | Roman | Devanagari | |
|---|---|---|---|
| (Hindi) | (English) | Unicode | Roman Unicode |
| [symbol] | u | U+0909 | U+0055 |
| [symbol] | s | U+0938 | U+0053 |
| [symbol] | ka | U+0915 | U+004BU+0041 |
| [symbol] | a | U+093E | U+0041 |
| [symbol] | na | U+0928 | U+004EU+0041 |
| [symbol] | m | U+092E | U+004D |

As shown in Table 2, the mapping function can directly map Unicode U+0909 to U+0055 for Devanagari (Hindi) to Roman (English) transliteration purposes. Once all of these mappings are determined, the mapping function can be utilized to decode a set of encoded characters corresponding to a text in order to obtain a transliteration of the text.

There may be two primary transliteration scenarios: (1) the user 108, via their computing device 104, inputs a text for transliteration and (ii) the user 108 uploads, via their computing device 104, a document file including text for transliteration. The former scenario is more straightforward, but the transliteration of an entire document file can be more complicated. The input/upload can be accompanied by a transliteration request (e.g., by clicking or selecting a button). The document file can include primarily text in the source script, but the document file could also include only text in the source script. For example, a portion of text in the document file that is not in the source script (e.g., a website address in a header/footer, a page number, etc.) could be filtered or removed when converting the document file. This filtered/removed information could later be restored when providing the computing device 104 with a transliterated document file.

The document file can be any type of file (text-based, image or rendering-based, etc.) that can be converted to a plain text tabular data structure. In one implementation, the plain text tabular data structure is a comma-separated values (CSV) file. In a CSV file, each portion of text (e.g., each word) is similar to its own table cell and separated from other portions of text by commas. Other similar file types could also be used, such as tab-delimited files where a tab character (e.g., a decimal value 9 or a hex value $09) is inserted between each portion of text. One primary benefit of utilizing a plain text tabular data structure for the median file is that any other file type can be transformed into it because it only consists of words and spaces. For example, an image or rendering-based file could have optical character recognition performed thereon to obtain the text for compiling the median file.

After obtaining the converted file (now a plain text tabular data structure), the computer server 112 can utilize the mapping function to convert the text in the converted document file from the source script to the target script to obtain a transliterated document file including a transliterated text. This can include, for example, encoding the characters in the converted document file to obtain encoded source characters, utilizing the mapping function to replace the encoded source characters with encoded target characters, and decoding the encoded target characters to obtain the transliterated document file including the transliterated text, which can then be transmitted to the computing device 104 as a download via the network 116. In some implementations, this transliterated document file can be stored at the computer server 112 (e.g., in memory) for future retrieval and usage. For example, the document may be a popular article or novel and thus many uses may wish to transliterate it to the target script in the future. This can save time and resources.

In some implementations, the computer server 112 can utilize the transliterated document file as part of creating a dictionary. In some cases, this dictionary can represent a bilingual dictionary for source and target languages associated with the source and target scripts, respectively. For this process, the computer server 112 can obtain encoded target words from the transliterated document file by using a space character as a delimiter. In other words, any blank space (e.g., space characters, comma characters, etc.) can be utilized to extract encoded target words from the transliterated document.

This set of encoded target words can then be replaced by a set of encoded source words using the mapping function. The computer server 112 can then decode the encoded source words to obtain source words in the source script. Finally, the computer server 112 can utilize the source words to create/maintain the dictionary. For a target language dictionary, for example, this can include comparing the source words to known source words in a database associated with the target language dictionary and, when the source words to not match any known source words, adding the source words to the target language dictionary.

Referring now to FIG. 2, a functional block diagram of an example computing device 200 is illustrated. The computing device 200 can be representative of one or both of the computing device 104 and the computer server 112. It will be appreciated, however, that these devices can have a slightly different configuration (e.g., the computing device 104 can include a display, such as a touch display, whereas the computer server 112 may not). The computing device 200 can include a communication device 204 (e.g., a transceiver), a processor 208, and a memory 212. The term “processor” as used herein can refer to both a single processor and two or more processors operating in a parallel or distributed architecture. The memory 212 can be any suitable non-transitory computer-readable storage medium (flash, hard disk, etc.) configured to store information at the computing device 200, such as a set of instructions that, when executed by the processor 208, causes the computing device 200 to perform at least a portion of the techniques of the present disclosure.

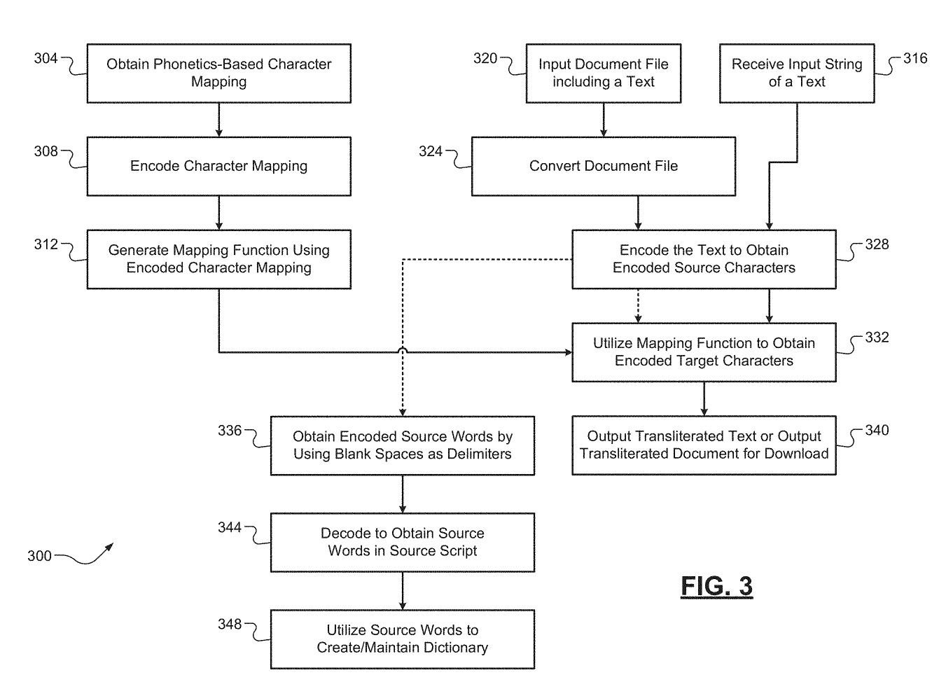

Referring now to FIG. 3, a flow diagram of an example phonetics-based computer transliteration technique 300 is illustrated. At 304, the computer server 112 can obtain a phonetics-based character mapping between a source script (e.g., Devanagari) and a different target script (e.g., Roman). This mapping, for example, may be pre-generated, such as by a linguistics professional. At 308, the computer server 112 can encode the phonetics-based character mapping (e.g., using Unicode) to obtain an encoded character mapping. At 312, the computer server 112 can generate or create a mapping function (e.g., a HashMap function) that maps encoded source characters to corresponding encoded target characters using the encoded character mapping.

At 316, the computer server 112 can receive an input string comprising a text of one or more words in the source script for transliteration to the target script. Alternatively, at 320, the computer server 112 can receive a document file (e.g., via a file upload) that contains primarily or entirely text in the source script and for transliteration to the target script. At 324, the computer server 112 can obtain a converted document file by converting the document file to a plain text tabular data structure (e.g., a CSV file) that is more appropriate for processing. At 328, the computer server 112 can encode the text of the input string or the converted document file to obtain encoded source characters. At 332, the computer server 112 can utilize the mapping function to replace the encoded source characters with encoded target characters of the target script.

Alternatively, at 336, the computer server 112 can utilize blank space characters as delimiters to obtain encoded source words. At 340, the computer server 112 can decode the encoded target characters to obtain characters in the target script that form a transliterated text. At 344, the transliterated text can be output or the transliterated document file can be converted back to its source format and then downloaded to the computing device 104. The technique 300 can then end or repeat for one or more cycles. At 344, the computer server 112 can decode the encoded source words to obtain source words in the source script. At 348, the computer server 112 can utilize these source words in creating and/or maintaining a dictionary. The technique 300 can then end or repeat for one or more cycles.

The disclosed techniques can create uniformity in describing semantics and syntactics of transliteration. As discussed herein, new language semantics are described using phonetics. The disclosed techniques (e.g., software) can be extended to other areas, such as for building a local transliteration application (e.g., for mobile computing devices). Another possible extension is the creation of a database of transliterated words that can be used for a multi-script keyboard (e.g., a Hinglish keyboard, which is a combination of Hindi and English). One other possible extension previously discussed herein is a dictionary, such as for a web-based application. As previously mentioned, every transliterated document file may be subsequently stored and later retrieved by or provided to other users (e.g., if the transliterated document file were a popular article or novel, there may be many users that wish to have it transliterated). This could decrease future computing resources. Other possible extensions include education, where these techniques can be utilized for teaching users proper transliteration and/or for transliterating large corpora (e.g., textbooks) for schools.

Further to the descriptions above, a user may be provided with controls allowing the user to make an election as to both if and when systems, programs or features described herein may enable collection of user information (e.g., information about a user's current location), and if the user is sent content or communications from a computer server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include: an Application Specific Integrated Circuit (ASIC); an electronic circuit; a combinational logic circuit; a field programmable gate array (FPGA); a processor or a distributed network of processors (shared, dedicated, or grouped) and storage in networked clusters or datacenters that executes code or a process; other suitable components that provide the described functionality; or a combination of some or all of the above, such as in a system-on-chip. The term module may also include memory (shared, dedicated, or grouped) that stores code executed by the one or more processors.

The term code, as used above, may include software, firmware, byte-code and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present invention.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method, comprising:
obtaining, by a computer server having one or more processors, a phonetics-based character mapping between a source script and a different target script, the phonetics-based character mapping relating characters in the source and target scripts that have similar sounds or pronunciations;
encoding, by the computer server, each character of the phonetics-based character mapping using an encoding scheme to obtain an encoded character mapping, wherein the encoding scheme is common to both the source and target scripts;
generating, by the computer server, a mapping function that directly maps encoded source script characters to encoded target script characters in the encoded character mapping; and
in response to a transliteration request, utilizing, by the computer server, the mapping function to transliterate a text from the source script to the target script.

2. The computer-implemented method of claim 1, wherein utilizing the mapping function to transliterate the text includes:
encoding, by the computer server, source characters of the text using the encoding scheme to obtain encoded source characters;
utilizing the mapping function, replacing, by the computer server, the encoded source characters with corresponding encoded target characters; and
decoding, by the computer system, the encoded target characters using the encoding scheme to obtain target characters of the transliterated text.

3. The computer-implemented method of claim 2, further comprising:
receiving, at the computer server and from a computing device, an upload comprising (i) a document file including the text and (ii) the transliteration request;
converting, by the computer server, the document file to a plain text tabular data structure to obtain a converted document file;
utilizing, by the computer server, the mapping function to convert the text in the converted document file from the source script to the target script to obtain a transliterated document file including the transliterated text; and
transmitting, from the computer server and to the computing device, the transliterated document file.

4. The computer-implemented method of claim 3, wherein the plain text tabular data structure is comma-separated values (CSV).

5. The computer-implemented method of claim 3, further comprising:
obtaining, by the computer server, encoded target words from the transliterated document file by using a space character as a delimiter;
utilizing the mapping function, replacing, by the computer server, the target encoded words with encoded source words;
decoding, by the computer server, the encoded source words using the encoding scheme to obtain source words in the source script; and
utilizing, by the computer server, the source words to create a dictionary for a target language associated with the target script.

6. The computer-implemented method of claim 5, wherein utilizing the source words to create the target language dictionary includes:
comparing, by the computer server, the source words to known source words in a database associated with the target language dictionary; and
when the source words to not match any known source words, adding, by the computer server, the source words to the target language dictionary.

7. The computer-implemented method of claim 2, further comprising:
receiving, at the computer server and from a computing device, an input comprising (i) the text (ii) the transliteration request;
utilizing, by the computer server, the mapping function to convert the text from the source script to the target script to obtain a transliterated text; and
outputting, from the computer server and to the computing device, the transliterated text.

8. The computer-implemented method of claim 1, wherein the phonetics-based character mapping is a data structure that includes (i) source sets of characters in the source script having similar sounds or pronunciations as and separated by a colon from (ii) respective target sets of characters in the target script.

9. The computer-implemented method of claim 1, wherein the mapping function is the HashMap function.

10. The computer-implemented method of claim 1, wherein the encoding scheme is Unicode.

11. A computer server including one or more processors and a non-transitory memory having a set of instructions stored thereon that, when executed by the one or more processors, causes the computer server to perform operations comprising:
obtaining a phonetics-based character mapping between a source script and a different target script, the phonetics-based character mapping relating characters in the source and target scripts that have similar sounds or pronunciations;
encoding each character of the phonetics-based character mapping using an encoding scheme to obtain an encoded character mapping, wherein the encoding scheme is common to both the source and target scripts;
generating a mapping function that directly maps encoded source script characters to encoded target script characters in the encoded character mapping; and
in response to a transliteration request, utilizing the mapping function to transliterate a text from the source script to the target script.

12. The computer server of claim 11, wherein utilizing the mapping function to transliterate the text includes:
encoding source characters of the text using the encoding scheme to obtain encoded source characters;
utilizing the mapping function, replacing the encoded source characters with corresponding encoded target characters; and
decoding the encoded target characters using the encoding scheme to obtain target characters of the transliterated text.

13. The computer server of claim 12, wherein the operations further comprise:
receiving, from a computing device, an upload comprising (i) a document file including the text and (ii) the transliteration request;
converting the document file to a plain text tabular data structure to obtain a converted document file;
utilizing the mapping function to convert the text in the converted document file from the source script to the target script to obtain a transliterated document file including the transliterated text; and
transmitting, to the computing device, the transliterated document file.

14. The computer server of claim 13, wherein the plain text tabular data structure is comma-separated values (CSV).

15. The computer server of claim 13, wherein the operations further comprise:
obtaining encoded target words from the transliterated document file by using a space character as a delimiter;
utilizing the mapping function, replacing the target encoded words with encoded source words;
decoding the encoded source words using the encoding scheme to obtain source words in the source script; and
utilizing the source words to create a dictionary for a target language associated with the target script.

16. The computer server of claim 15, wherein utilizing the source words to create the target language dictionary includes:
comparing the source words to known source words in a database associated with the target language dictionary; and
when the source words to not match any known source words, adding the source words to the target language dictionary.

17. The computer server of claim 12, wherein the operations further comprise:
receiving, from a computing device, an input comprising (i) the text (ii) the transliteration request;
utilizing the mapping function to convert the text from the source script to the target script to obtain a transliterated text; and
outputting, from the computer server and to the computing device, the transliterated text.

18. The computer server of claim 11, wherein the phonetics-based character mapping is a data structure that includes (i) source sets of characters in the source script having similar sounds or pronunciations as and separated by a colon from (ii) respective target sets of characters in the target script.

19. The computer server of claim 11, wherein the mapping function is the HashMap function.

20. The computer server of claim 11, wherein the encoding scheme is Unicode.
